(19) United States
(12) Patent Application Publication
(10) Pub. No.: US 2023/0124701 A1
(43) Pub. Date: Apr. 20, 2023

(54) CONTROL BOX

(71) Applicant: KUNSHAN JUNLEI ELECTRONIC CO., LTD., Kunshan City (CN)

(72) Inventor: JI HUANG, Kunshan City (CN)

(21) Appl. No.: 17/735,762

(22) Filed: May 3, 2022

(30) Foreign Application Priority Data
Oct. 14, 2021 (TW) 110138237

(51) Int. Cl. H01R 13/645; H01R 13/05; H01R 13/11; H01R 13/627; H01R 13/02; H01R 13/52

(52) U.S. Cl. CPC H01R 13/6456; H01R 13/05; H01R 13/11; H01R 13/025; H01R 13/52; H01R 13/6271; H01R 2103/00

(57) ABSTRACT

A control box includes a housing, and a plurality of positive and negative plug connectors protruded and fastened on a cable let-out surface of the housing. The plurality of positive and negative plug connectors are different from each other, and each of structures of the plurality of positive and negative plug connectors is selected from a group including a dual male plug transmission-end structure and a dual female plug transmission-end structure. The dual female plug transmission-end structure is matched with a dual male plug transmission cable, and the dual male plug transmission cable includes the dual male plug transmission-end structure; the dual male plug transmission-end structure is matched with a dual female plug transmission cable, and the dual female plug transmission cable includes the dual female plug transmission-end structure.

### BACKGROUND

### 1. Technical Field

The disclosure is related to a control box, and more particularly to a control box having positive and negative plug connectors.

### 2. Background

Electric bicycles, electric vehicles and motor vehicles require specific transmission cables in the transmission of signals and power. The signal transmission is performed through a specific transmission cable header; in addition, to prevent confusion with different transmission cables, different transmission cables for different control parts often adopt different transmission cable headers.

For example, China Patent No. CN101728809A, discloses a motor control box applying the conventional technology in which the signal cables are connected to a motor control circuit board through holes, so that a box body of the motor control box can be connected to the motor control circuit board through the signal cables. The above-mentioned technology is the connection method of the motor control boxes of motor vehicles, electric bicycles, or electric vehicles, and it is a well-known and mature cable connector technology to those having ordinary skill in the art.

However, according to the content of China Patent No. CN101728809A, when the conventional motor control box is shipped, it is necessary to pay attention to whether any signal cable is damaged during the packaging and shipping process because the signal cable is exposed to the outside. In addition, connectors must use connector heads of different specifications to prevent the technician, who installs the motor control box, from connecting the wrong cables; that is, an anti-mistaking function is required. However, the conventional signal connection cable using a simple buckle manner has a less waterproof effect.

Therefore, how to develop an improved solution that can maintain the anti-mistaking function and also solve the problem that signal cables may be damaged during shipping to improve the waterproof ability of the connected signal cable, is an important technological development direction for the development of motor control boxes.

### SUMMARY

In order to solve the conventional technology problem, an objective of the disclosure is to provide a control box has positive and negative plug connectors, and a plurality of connectors are mounted on a box body of the control box, so as to prevent the signal cable from being exposed to the outside; furthermore, the box body of the control box of the disclosure can be kept in original size and provide a better waterproof function by using the smaller positive and negative plug connectors; furthermore, configuring the positive and negative plug connectors with different sizes, different shapes or different colors is able to achieve the technical effects of providing higher waterproof level and greatly improving shipping security.

In order to achieve the above-mentioned objective, the disclosure provides a control box has positive and negative plug connectors, and the control box includes a housing, and a plurality of positive and negative plug connectors protruded and fastened on a cable let-out surface of the housing, wherein the plurality of positive and negative plug connectors are different from each other, and each of structures of the plurality of positive and negative plug connectors is selected from a group including a dual male plug transmission-end structure and a dual female plug transmission-end structure. The dual male plug transmission-end structure includes a first protruding portion and a second protruding portion forming a dual male plug, the first protruding portion is disposed on a central part of the dual male plug, the second protruding portion is ring-shaped, a third groove is formed between the first protruding portion and the second protruding portion, the second protruding portion is ring-shaped, the first protruding portion comprises first upper and lower surfaces, at least two upper conductive interface and at least two lower conductive interface are disposed on the upper and lower surfaces, respectively, the at least two upper conductive interfaces and the at least two lower conductive interface are conductively connected in a diagonal matching configuration and arranged in symmetry with each other. The dual female plug transmission-end structure includes a third protruding portion and a fourth protruding portion forming a dual female plug, the third protruding portion is ring-shaped and forms a first groove, the first groove is formed at a central part of the dual female plug, the fourth protruding portion is ring-shaped, a second groove is formed between the fourth protruding portion and the third protruding portion, the first groove inside the third protruding portion comprises second upper and lower surfaces, at least two upper conductive spring clips and at least two lower conductive spring clips are disposed on the upper and lower surfaces, respectively, the at least two upper conductive spring clips and the at least two lower conductive spring clips are conductively connected in a diagonal matching configuration and arranged in symmetry with each other. The dual female plug transmission-end structure is matched with a dual male plug transmission cable, the dual male plug transmission cable comprises the dual male plug transmission-end structure, the dual male plug transmission-end structure is matched with a dual female plug transmission cable, the dual female plug transmission cable comprises the dual female plug transmission-end structure.

### BRIEF DESCRIPTION OF THE DRAWINGS

The structure, operating principle, and effects of the disclosure will be described in detail by way of various embodiments which are illustrated in the accompanying drawings.

FIGS. 1A and 1B show a particular embodiment of a control box with positive and negative plug connectors, according to the disclosure.

FIGS. 2A and 2B show another embodiment of a control box with positive and negative plug connectors, according to the disclosure.

FIGS. 3A and 3B show another embodiment of a control box with positive and negative plug connectors, according to the disclosure.

FIGS. 4A and 4B show another embodiment of a control box with positive and negative plug connectors, according to the disclosure.

FIG. 5A is a perspective view of a dual female plug transmission-end structure and a dual male plug transmission-end structure, according to the disclosure.

FIGS. 5B and 5C are schematic views showing connections between electrodes of a dual female plug transmission-end structure and a dual male plug transmission-end structure of the disclosure, respectively.

### DETAILED DESCRIPTION

The following embodiments of the disclosure are herein described in detail with reference to the accompanying drawings. These drawings show specific examples of the embodiments of the disclosure. These embodiments are provided so that this disclosure will be thorough and complete, and will fully convey the scope of the invention to those skilled in the art. It is to be acknowledged that these embodiments are exemplary implementations and are not to be construed as limiting the scope of the disclosure in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The disclosure provides a control box with positive and negative plug connectors, and a plurality of connectors are mounted on a box body of the control box, so that the signal cable can be prevented from being exposed to the outside, and the box body of the control box can be kept in original size and provide better waterproof function by using the smaller positive and negative plug connectors. Furthermore, configuring the positive and negative plug connectors with different sizes, different shapes, or different colors can achieve the technical effects of providing a higher waterproof level and greatly improving shipping security. The control box of the disclosure can be applied to motor control boxes of electric motorcycles, electric bicycles, motor vehicles, various large-sized instruments which need multiple signal transmission cables, various machinery apparatus control boxes which need multiple signal transmission cables, and various fields in which the waterproof function is required.

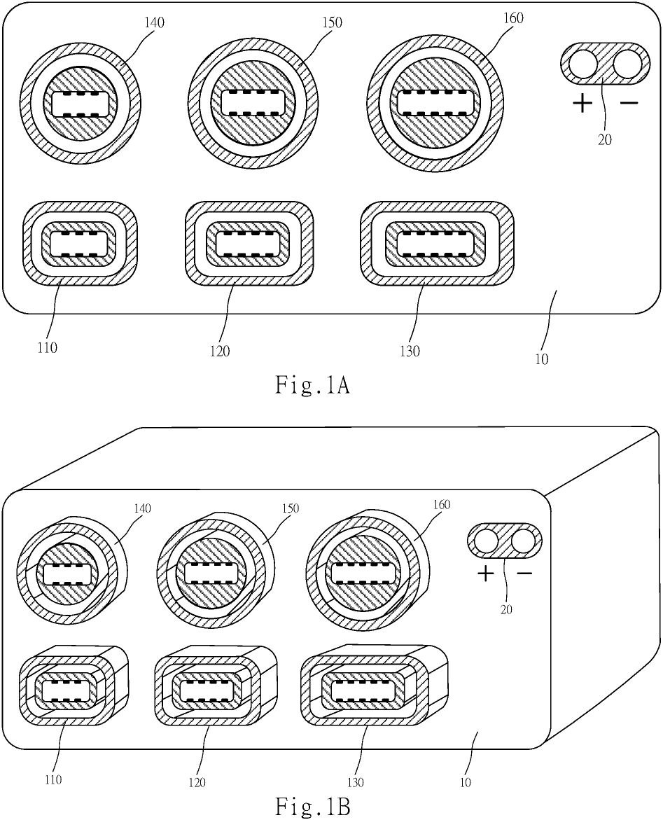

Please refer to FIGS. 1A and 1B, which are a front view and an elevational view of a particular embodiment of a control box of the disclosure. The control box includes a housing 10 and a plurality of positive and negative plug connectors. In this embodiment, the control box includes six positive and negative plug connectors including positive and negative plug connectors 110~160. All positive and negative plug connectors are protruded and fastened on a cable let-out surface of the housing 10; furthermore, the positive and negative plug connectors are different from each other, and each of the structures of the positive and negative plug connectors is a dual female plug transmission-end structure.

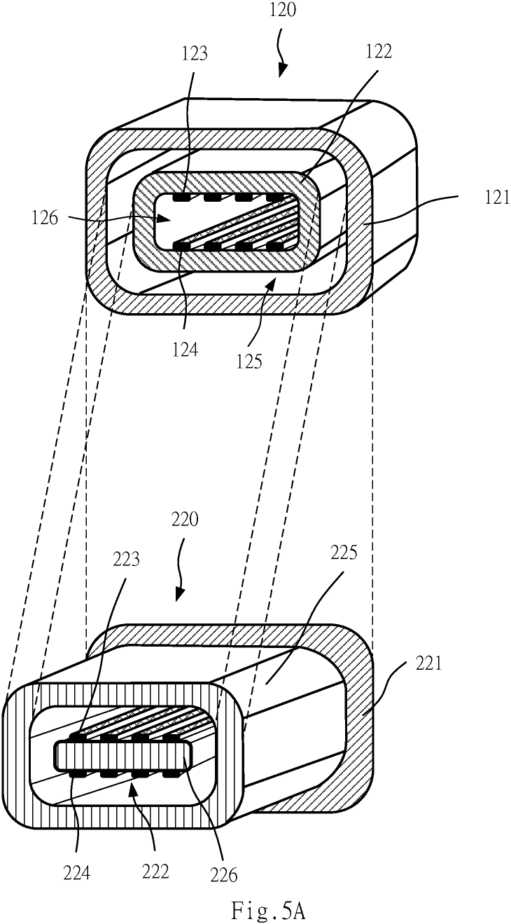

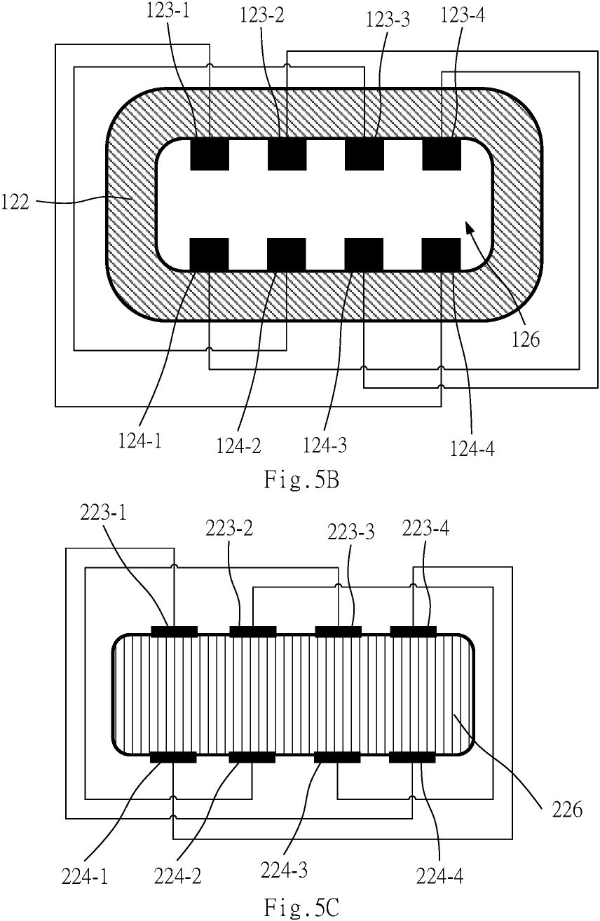

Please first refer to FIG. 5A, which is a elevational view of the dual female plug transmission-end structure and the dual male plug transmission-end structure of the disclosure. The positive and negative plug connector 120 has a dual female plug transmission-end structure which includes a third protruding portion 122 and a fourth protruding portion 121 forming a dual female plug. The third protruding portion 122 is ring-shaped and forms a first groove 126, and the first groove 126 is formed at a central part of the dual female plug; the fourth protruding portion 121 is ring-shaped, and a second groove 125 is formed between the third protruding portion 122 and the fourth protruding portion 121. The third protruding portion 122 has a top surface and a bottom surface formed therein, at least two upper conductive spring clips 123 and at least two lower conductive spring clips 124 are disposed on the upper and lower surfaces, respectively. The at least two upper conductive spring clips 123 and the at least two lower conductive spring clips 124 are conductively connected in a diagonal matching configuration and arranged in symmetry with each other, as shown in FIG. 5B.

In an embodiment shown in FIGS. 5A and 5B, the positive and negative plug connector 120 includes four upper conductive spring clips disposed on an inner top surface of the third protruding portion 122, and the four upper conductive spring clips includes an upper conductive spring clip 123-1, an upper conductive spring clip 123-2, an upper conductive spring clip 123-3 and an upper conductive spring clip 123-4; four lower conductive spring clips are disposed on an inner bottom surface of the third protruding portion 122 and include an lower conductive spring clip 124-1, an lower conductive spring clip 124-2, an lower conductive spring clip 124-3 and an lower conductive spring clip 124-4. The upper conductive spring clip 123-1, the upper conductive spring clip 123-2, the upper conductive spring clip 123-3 and the upper conductive spring clip 123-4 are respectively electrically connected to the lower conductive spring clip 124-4, the lower conductive spring clip 124-3, the lower conductive spring clip 124-2 and the lower conductive spring clip 124-1 to form diagonal matching configuration and a symmetry structure, as shown in FIG. 5B.

According to the embodiment of FIG. 1B, the embodiment adopts the positive and negative plug connectors having two different shapes, for example, a positive and negative plug connectors 110, a positive and negative plug connectors 120 and a positive and negative plug connectors 130 are in a rectangular shape with circular corners, and the positive and negative plug connectors 140, the positive and negative plug connectors 150 and the positive and negative plug connectors 160 are in circular shape. A power plug 20 is disposed on the housing 10; furthermore, the positive and negative plug connectors 110, the positive and negative plug connectors 120 and the positive and negative plug connectors 130, which are in the same rectangular shape with circular corners, have different sizes, and also have different amounts of the upper conductive spring clips and the lower conductive spring clips, for example, the positive and negative plug connectors 110 can include three upper conductive spring clips and three lower conductive spring clips, the positive and negative plug connectors 120 can include four upper conductive spring clips and four lower conductive spring clips, the positive and negative plug connectors 130 can include five upper conductive spring clips and five lower conductive spring clips. Similarly, the positive and negative plug connectors 140, the positive and negative plug connectors 150 and the positive and negative plug connectors 160, which are in the same circular shapes, have different sizes and different amounts of the upper conductive spring clips and the lower conductive spring clips; for example, the positive and negative plug connectors 140 can include three upper conductive spring clips and three lower conductive spring clips, the positive and negative plug connectors 150 can includes four upper conductive spring clips and four lower conductive spring clips, and the positive and negative plug connectors 160 can include five upper conductive spring clips and five lower conductive spring clips.

Furthermore, in another embodiment of the disclosure, the positive and negative plug connectors can have different exterior colors, for example, the color on the outer surfaces around the fourth protruding portions of the positive and negative plug connectors 110, the positive and negative plug connectors 120, the positive and negative plug connectors 130, the positive and negative plug connectors 140, the positive and negative plug connectors 150 and the positive and negative plug connectors 160; in another embodiment, the housing 10 can be coated with different color for differentiation. In other words, the color configured on the exterior of the positive and negative plug connectors is the color of the positive and negative plug connectors or the exterior color of the housing. As a result, the user can identify the difference.

Furthermore, in another embodiment of the disclosure, differences between the positive and negative plug connectors can be simply set as the different exterior colors. In other words, sizes and shapes of the positive and negative plug connectors can be the same, even the amounts of the internal upper conductive spring clip and lower conductive spring clip can be the same, and the positive and negative plug connectors are differentiated by colors only.

In another embodiment of the disclosure, different features between positive and negative plug connectors can include different sizes, different shapes, different colors, different amounts of the conductive spring clips; that is, one or at least two of the technical features can be selected to use for differentiation.

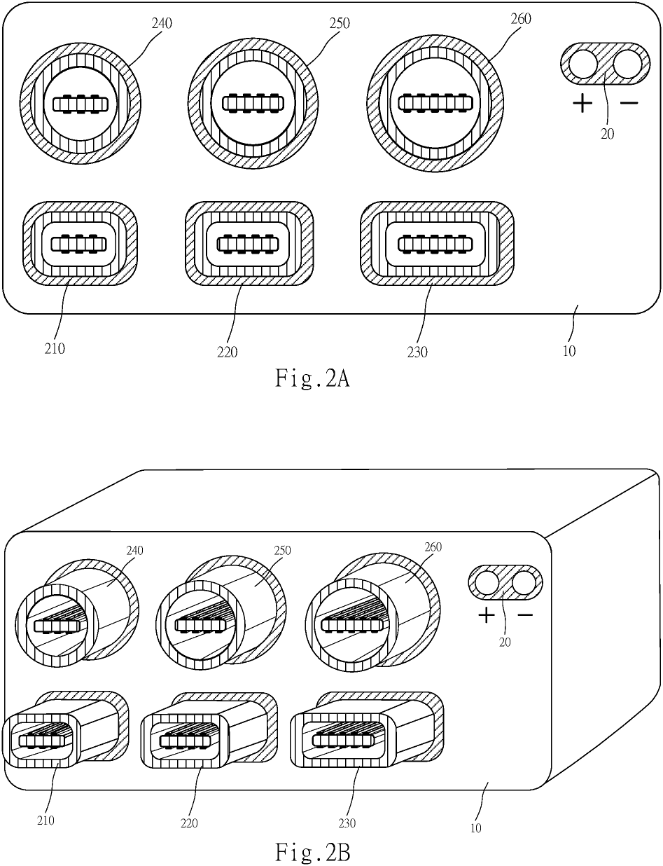

Please refer to FIGS. 2A and 2B, which show a front view and an elevational view of another particular embodiment of a control box with positive and negative plug connectors, according to the disclosure. The control box includes a housing 10 and a plurality of positive and negative plug connectors. In this embodiment, there are six positive and negative plug connectors including a positive and negative plug connector 210, a positive and negative plug connector 220, a positive and negative plug connectors 230, a positive and negative plug connector 240, and a positive and negative plug connector 250, and a positive and negative plug connector 260 are protruded and fastened on a cable let-out surface of the housing 10; furthermore, the six positive and negative plug connectors are different from each other, and each of the structures of the positive and negative plug connectors is the dual male plug transmission-end structure.

Please refer to FIG. 5A, the elevational view of a dual female plug transmission-end structure and a dual male plug transmission-end structure of the disclosure. The positive and negative plug connector 220 is a dual male plug transmission-end structure and includes a first protruding portion 226 and a second protruding portion 225 which form a dual male plug. The first protruding portion 226 is disposed on a central part of the dual male plug, and the second protruding portion 225 is ring-shaped, and a ring-shaped third groove 222 is formed between the first protruding portion 226 and the second protruding portion 225. The first protruding portion 226 includes upper and lower surfaces, at least two upper conductive interfaces 223 and at least two lower conductive interfaces 224 are disposed on the upper and lower surfaces, respectively. The at least two upper conductive interfaces 223 and the at least two lower conductive interfaces 224 are conductively connected in a diagonal matching configuration and arranged in symmetry with each other, as shown in FIG. 5C.

As shown in FIG. 5A, the dual male plug transmission-end structure of the positive and negative plug connectors 220 includes an edge ring portion 221 corresponding to the fourth protruding portion 121 of the dual female plug transmission-end structure of the positive and negative plug connectors 120; that is, when the dual male plug transmission-end structure and the dual female plug transmission-end structure, which have the same sizes, the same shapes and the same amounts of conductive spring clips/conductive interfaces, are combined with each other, the fourth protruding portion is stopped in the edge ring portion.

In an embodiment shown in FIGS. 5A and 5C, the positive and negative plug connectors 220 includes four upper conductive interfaces disposed on an upper surface of the first protruding portion 226, and four lower conductive interfaces disposed on a lower surface of the first protruding portion 226. The four upper conductive interfaces include upper conductive interfaces 223-1~223-4, and the four lower conductive interfaces include lower conductive interfaces 224-1~224-4. The upper conductive interface 223-1, the upper conductive interface 223-2, the upper conductive interface 223-3 and the upper conductive interface 223-4 are electrically connected to the lower conductive interface 224-4, the lower conductive interface 224-3, the lower conductive interface 224-2 and the lower conductive interface 224-1, respectively, to form a symmetrical structure, as shown in FIG. 5C.

According to the embodiment of FIG. 2B, the embodiment adopts the positive and negative plug connectors with two different shapes, and the positive and negative plug connectors include positive and negative plug connectors 210-230 in rectangular shapes with circular corners and positive and negative plug connectors 240-260 in circular shapes. Furthermore, the positive and negative plug connectors 210~230 in the same rectangular shapes with circular corners have different sizes, and different amounts of the upper conductive interfaces and the lower conductive interfaces; for example, the positive and negative plug connectors 210 includes three upper conductive interfaces and three lower conductive interfaces, the positive and negative plug connectors 220 includes four upper conductive interfaces and four lower conductive interfaces, the positive and negative plug connectors 230 includes five upper conductive interfaces and five lower conductive interfaces. Similarly, the positive and negative plug connectors 240-260 in the same circular shapes have different sizes, and different amounts of the upper conductive interfaces and the lower conductive interfaces; for example, the positive and negative plug connectors 240 includes three upper conductive interfaces and three lower conductive interfaces, the positive and negative plug connectors 250 includes four upper conductive interfaces and four lower conductive interfaces, the positive and negative plug connectors 260 includes five upper conductive interfaces and five lower conductive interfaces.

The embodiment shown in FIGS. 1A and 1B and the embodiment shown in FIGS. 2A and 2B illustrate the embodiments of the disclosure adopting the same transmission-end structures in the control box, such as the embodiment using the dual female plug transmission-end structures, or the embodiment using the dual male plug transmission-end structures. Furthermore, two embodiments which adopt two different transmission-end structures in one control box will be described in the following paragraphs.

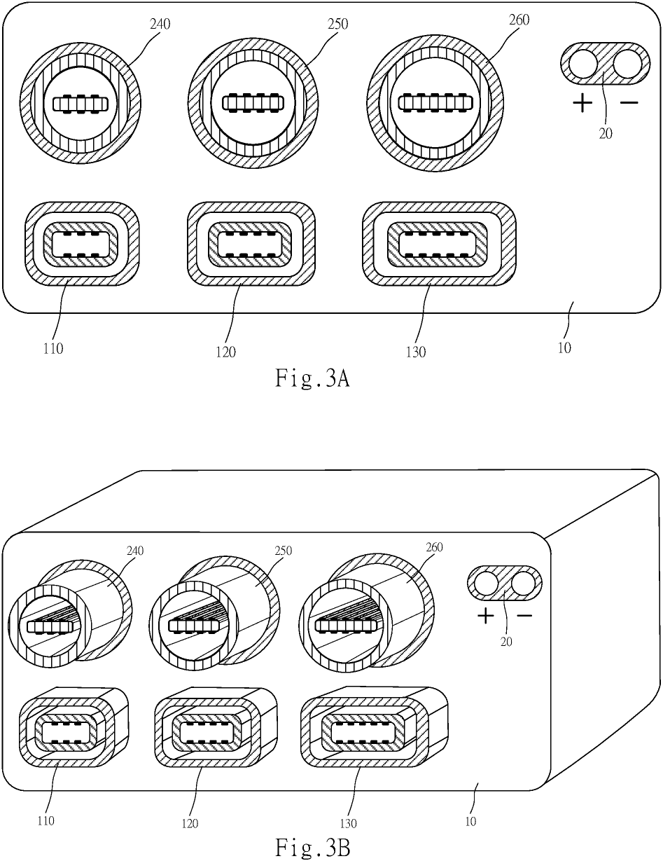

Please refer to FIGS. 3A and 3B, which are a front view and an elevational view of another embodiment of a control box with positive and negative plug connectors, according to the disclosure. As shown in FIGS. 3A and 3B, the control box includes the housing 10 and the plurality of positive and negative plug connectors; in this embodiment, six positive and negative plug connectors 110~130 and 240-260 are protruded and fastened on a cable let-out surface of the housing 10; furthermore, the positive and negative plug connectors 110~130 and 240-260 are different from each other, for example, the positive and negative plug connectors 110~130 are the dual female plug transmission-end structures, and the positive and negative plug connectors 240~260 are the dual male plug transmission-end structures. In this embodiment, the positive and negative plug connectors with the same shapes have different sizes and have the same transmission-end structures.

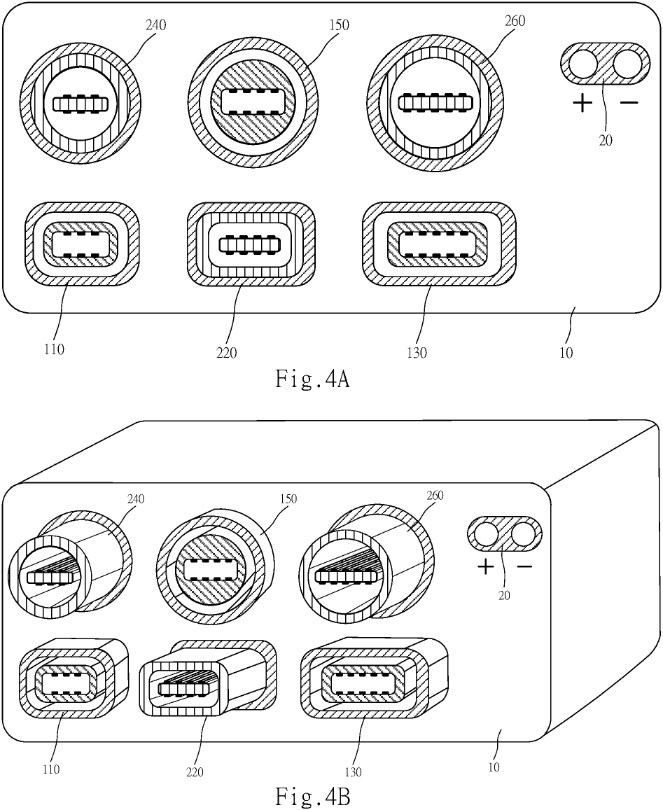

Please refer to FIGS. 4A and 4B, which are a front view and an elevational view of another particular embodiment of a control box with positive and negative plug connectors, according to the disclosure. As shown in 4A and 4B, the control box includes the housing 10 and the plurality of positive and negative plug connectors. In this embodiment, there are six positive and negative plug connectors including a positive and negative plug connector 110, a positive and negative plug connector 220, a positive and negative plug connectors 130, a positive and negative plug connector 240, and a positive and negative plug connector 150, and a positive and negative plug connector 260 are protruded and fastened on a cable let-out surface of the housing 10; furthermore, the positive and negative plug connectors are different each other, and the structures of the positive and negative plug connectors the positive and negative plug connectors 110, the positive and negative plug connectors 130 and the positive and negative plug connectors 150 are the dual female plug transmission-end structures, and the positive and negative plug connectors 220, the positive and negative plug connectors 240, and the positive and negative plug connectors 260 are the dual male plug transmission-end structures. In this embodiment, the positive and negative plug connectors with the same shapes have different sizes and different transmission-end structures.

The dual male plug transmission-end structure and the dual female plug transmission-end structure are matched with each other when their shapes are the same and the sizes are the same; in other words, when their shapes are the same and their sizes are the same, the amounts of the upper and lower conductive spring clips or the upper and lower conductive interfaces are also the same, so the transmission-end structures can be differentiated by colors. Because the positive and negative plug connectors configured on the control box of the disclosure are to connect the corresponding positive and negative plug transmission cables, in practice, the dual female plug transmission-end structure can be matched with a dual male plug transmission cable, the dual male plug transmission cable includes the dual male plug transmission-end structure; the dual male plug transmission-end structure can be matched with a dual female plug transmission cable, and the dual female plug transmission cable includes the dual female plug transmission-end structure. If the positive and negative plug connectors of the control box of the disclosure are configured with different structures, different sizes or different shapes, the user can select corresponding and matching transmission cables to directly combine with the positive and negative plug connectors of the control box easily.

According to different embodiments, the control box with positive and negative plug connectors of the disclosure is to directly dispose the positive and negative plug connectors having the dual male plug transmission-end structures and the dual female plug transmission-end structures on the cable let-out surface of the control box, so as to solve the technical problem that the transmission cable of the conventional motor control box are exposed out, thereby implementing the effect that no signal cable is exposed out of the housing; furthermore, the control box with positive and negative plug connectors of the disclosure adopts the dual male plug transmission-end structures and the dual female plug transmission-end structures to provide better waterproof function and waterproof effect. Furthermore, with the configuration of different sizes, different shapes, different colors, or different amounts of the conductive spring clips/conductive interfaces, the disclosure can meet the requirement in differentiation for various signal transmission ends with the same transmission-end structures, so that the product designer can have various product design assembly effect under the same transmission-end structure, and there is no need to worry about lack of available signal terminals. With the uniform transmission-end structures, the disclosure has another technical effect of greatly reducing the maintenance cost of the different connector structure.

The disclosure disclosed herein has been described by means of specific embodiments. However, numerous modifications, variations and enhancements can be made thereto by those skilled in the art without departing from the spirit and scope of the disclosure set forth in the claims.

What is claimed is:

1. A control box, comprising:
a housing; and
a plurality of positive and negative plug connectors protruded and fastened on a cable let-out surface of the housing, wherein the plurality of positive and negative plug connectors are different from each other, and each of structures of the plurality of positive and negative plug connectors is selected from a group comprising:
a dual male plug transmission-end structure comprising a first protruding portion and a second protruding portion forming a dual male plug, wherein the first protruding portion is disposed on a central part of the dual male plug, the second protruding portion is ring-shaped, a third groove is formed between the first protruding portion and the second protruding portion, the second protruding portion is ring-shaped, the first protruding portion comprises first upper and lower surfaces, at least two upper conductive interface and at least two lower conductive interface are disposed on the upper and lower surfaces, respectively, the at least two first upper conductive interfaces and the at least two lower conductive interface are conductively connected in a diagonal matching configuration and arranged in symmetry with each other; and
a dual female plug transmission-end structure comprising a third protruding portion and a fourth protruding portion forming a dual female plug, wherein the third protruding portion is ring-shaped and forms a first groove, the first groove is formed at a central part of the dual female plug, the fourth protruding portion is ring-shaped, a second groove is formed between the fourth protruding portion and the third protruding portion, the first groove inside the third protruding portion comprises second upper and lower surfaces, at least two upper conductive spring clips and at least two lower conductive spring clips are disposed on the second upper and lower surfaces, respectively, the at least two upper conductive spring clips and the at least two lower conductive spring clips are conductively connected in a diagonal matching configuration and arranged in symmetry with each other;
wherein the dual female plug transmission-end structure is matched with a dual male plug transmission cable, the dual male plug transmission cable comprises the dual male plug transmission-end structure, the dual male plug transmission-end structure is matched with a dual female plug transmission cable, the dual female plug transmission cable comprises the dual female plug transmission-end structure.

2. The control box with positive and negative plug connectors according to claim 1, wherein the structures of the plurality of positive and negative plug connectors are the dual male plug transmission-end structures or the dual female plug transmission-end structures, and sizes of the plurality of positive and negative plug connectors are different from each other.

3. The control box with positive and negative plug connectors according to claim 2, wherein the dual male plug transmission-end structures of the plurality of positive and negative plug connectors have different amounts of the at least two upper conductive interfaces; the dual female plug transmission-end structures of the plurality of positive and negative plug connectors have different amounts of the at least two upper conductive interfaces.

4. The control box with positive and negative plug connectors according to claim 1, wherein the structures of the plurality of positive and negative plug connectors are the dual male plug transmission-end structures or the dual female plug transmission-end structures, and shapes of some of the plurality of positive and negative plug connectors are different from each other.

5. The control box with positive and negative plug connectors according to claim 4, wherein the dual male plug transmission-end structures of the positive and negative plug connectors having the same shapes have different amounts of the at least two upper conductive interfaces; the dual female plug transmission-end structures of the positive and negative plug connectors having the same shapes have different amounts of the at least two upper conductive interfaces.

6. The control box with positive and negative plug connectors according to claim 1, wherein the structures of the plurality of positive and negative plug connectors are the dual male plug transmission-end structures or the dual female plug transmission-end structures, and the plurality of positive and negative plug connectors have different exterior colors.

7. The control box with positive and negative plug connectors according to claim 1, wherein the structure of each of the plurality of positive and negative plug connectors is one of the dual male plug transmission-end structure and the dual female plug transmission-end structure, and the sizes of the plurality of positive and negative plug connectors are different from each other.

8. The control box with positive and negative plug connectors according to claim 1, wherein the structure of each of the plurality of positive and negative plug connectors is one of the dual male plug transmission-end structure and the dual female plug transmission-end structure, and shapes of some of the plurality of positive and negative plug connectors are different from each other.

9. The control box with positive and negative plug connectors according to claim 8, wherein the dual female plug transmission-end structure of the positive and negative plug connectors having the same shapes have different amounts of the at least two upper conductive spring clips, and the dual male plug transmission-end structure having the same shapes have different amount of the at least two upper conductive interfaces.

10. The control box with positive and negative plug connectors according to claim 1, wherein the structure of each of the plurality of positive and negative plug connectors is one of the dual male plug transmission-end structure and the dual female plug transmission-end structure, and the plurality of positive and negative plug connectors have different exterior colors.
